(19) United States
(12) Patent Application Publication
(10) Pub. No.: US 2001/0022199 A1
(43) Pub. Date: Sep. 20, 2001

(54) Oil pressure solenoid valve assembly

(76) Inventors: Junichi Tokunaga, Anjo-shi (JP); Hiroshi Tanaka, Anjo-shi (JP)

Correspondence Address: LORUSSO & LOUD, 3137 Mount Vernon Avenue, Alexandria, VA, 22305, US

(21) Appl. No.: 09/745,186

(22) Filed: Dec. 22, 2000

(30) Foreign Application Priority Data
Dec. 24, 1999 (JP) H11-368434

(51) Int. Cl. F16K 11/24

(52) U.S. Cl. 137/883

(57) ABSTRACT

An oil pressure solenoid valve assembly includes a single oil feed port and a plurality of oil discharge ports for discharging operating oil, and discharge of this operating oil at each oil discharge port is individually controlled by a respective solenoid valve. When such an oil pressure solenoid valve assembly is used in an oil pressure control circuit, the number of oil pressure assemblies can be decreased as compared to a conventional oil pressure solenoid valve assembly wherein each valve has only one discharge port. The number of oil feed passages connected to the operating oil feed port can also be decreased. As a consequence, the size and the weight of the oil pressure control apparatus can be reduced.

### BACKGROUND OF THE INVENTION

1. Field of the Invention

This invention relates to an oil pressure solenoid valve assembly including a single oil feed port and a plurality of oil discharge ports.

2. Description of the Related Art

An oil pressure solenoid valve assembly of a type that controls the supply and cut-off of oil, such as in control of oil operating pressure, has been employed in a variety of applications, including use in an automotive hydraulic controller of an automatic transmission.

FIGS. 6a and 6b show an example of a conventional oil pressure solenoid valve assembly A3. The oil pressure solenoid valve assembly A3 shown in the drawing includes a valve body 2 having one each of an oil feed port 3 and an oil discharge port 4. A feed oil passage, not shown, connects with the oil feed port 3. A valve member (disc) 7 is fitted in a chamber of a bore within the valve body 2 and is interposed between the oil feed port 3 and the oil discharge port 4. Solenoid 7 drives the valve member 8 to control supply of the operating oil (oil pressure).

The oil supply/cut-off operations of the solenoid valve assembly described above must be provided at a large number of positions inside a hydraulic controller required for complicated oil pressure control. The oil pressure solenoid valve assembly A3 described above can control the operation of only one such system. Therefore, a separate valve assembly must be provided at each position requiring such control. Moreover, a feed oil passage must be connected to the oil inlet port 3 of each oil pressure solenoid valve assembly. In other words, a feed oil passage must be provided for each of the valve assemblies. As a consequence, a large number of the valve assemblies and a large number of feed oil passages are required, and the size and the weight of the oil pressure apparatus itself is correspondingly large. The size and weight of the oil pressure apparatus (hydraulic controller) is never negligible in an automobile, for example, when used therein as a hydraulic controller for an automatic transmission.

### SUMMARY OF THE INVENTION

It is an object of this invention to provide an oil pressure solenoid valve assembly of reduced size and weight.

According to a first aspect, the present invention provides an oil pressure solenoid valve assembly including a single valve body having a central bore and an oil feed port and an oil discharge port extending through the valve body and communicating with the central bore, and a solenoid for switching and controlling communication of oil between the oil feed port and the oil discharge port by movement of a valve disc member fitted in the central bore. The oil pressure solenoid valve assembly includes a plurality of solenoids sharing in common a single oil feed port, and a plurality of discharge ports, each provided in association with one of the plurality of solenoids, respectively, whereby oil fed from the single oil feed port is supplied to or cut-off for each oil discharge port under control of a solenoid. In other words, the plural solenoid valves share in common the same single valve body interposed therebetween and the same single oil feed port.

According to a second aspect of this invention, two oil discharge ports are disposed with the single oil feed port interposed therebetween, and two solenoids and two valve members are disposed opposing one another with the single oil feed port interposed therebetween.

According to a third aspect of this invention, the valve members of the two solenoid valves are aligned within their respective chambers on the same (common) axis, opposing each other.

### BRIEF DESCRIPTION OF THE DRAWINGS

Preferred embodiments of the invention will now be described in conjunction with the appended drawings in which like features are designated with like reference characters, and wherein:

FIGS. 1(a) and 1(b) show a first preferred embodiment of an oil pressure solenoid valve assembly according to this invention;

FIG. 2 shows a second embodiment of the oil pressure solenoid valve assembly according to this invention;

FIGS. 3(a) and 3(b) show an installation of the second embodiment of the oil pressure solenoid valve assembly according to this invention;

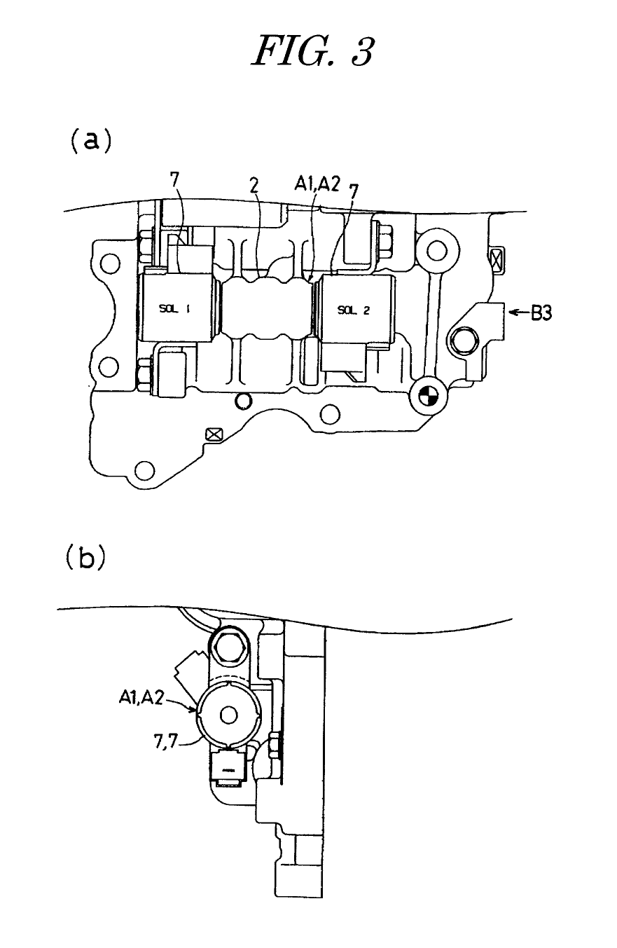

FIG. 4 is a schematic view of a stage-less (continuously variable) transmission to which this invention is applied;

FIG. 5 is a diagram of a hydraulic control circuit used for control of the stage-less transmission shown in FIG. 4;

FIGS. 6(a) and 6(b) show an example of a conventional oil pressure solenoid valve assembly; and

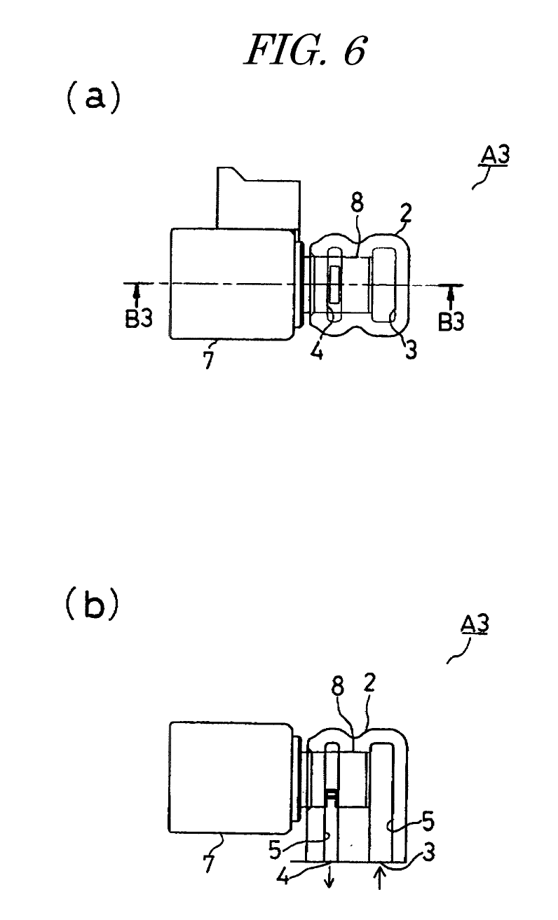

FIG. 7 is a sectional view showing details of an oil pressure solenoid valve according to this invention.

### DESCRIPTION OF THE PREFERRED EMBODIMENTS

In one aspect the invention provides an assembly of a plurality of solenoid valves which share a single oil feed port. Therefore, the number of the oil feed ports, which in the past has been equal to the number of solenoid valves in the assembly, can be decreased, and the overall size and weight of the whole of the solenoid valve assembly can be reduced.

In a second aspect of the invention a valve assembly has two oil discharge ports, two solenoids and two valve discs arranged opposing one another with the single oil feed port therebetween. Therefore, only one oil feed port is needed for two solenoids, and the number of oil feed ports can be reduced by half (in comparison with the conventional assembly wherein an oil feed port is provided for each oil discharge port).

According to the third aspect of the invention, the bores of two valve bodies are disposed on the same axis to form together one through-hole. This through-hole can be formed in a single boring, and the number of man-hours and the production cost can be reduced as compared with the case where the two valve bodies are individually bored.

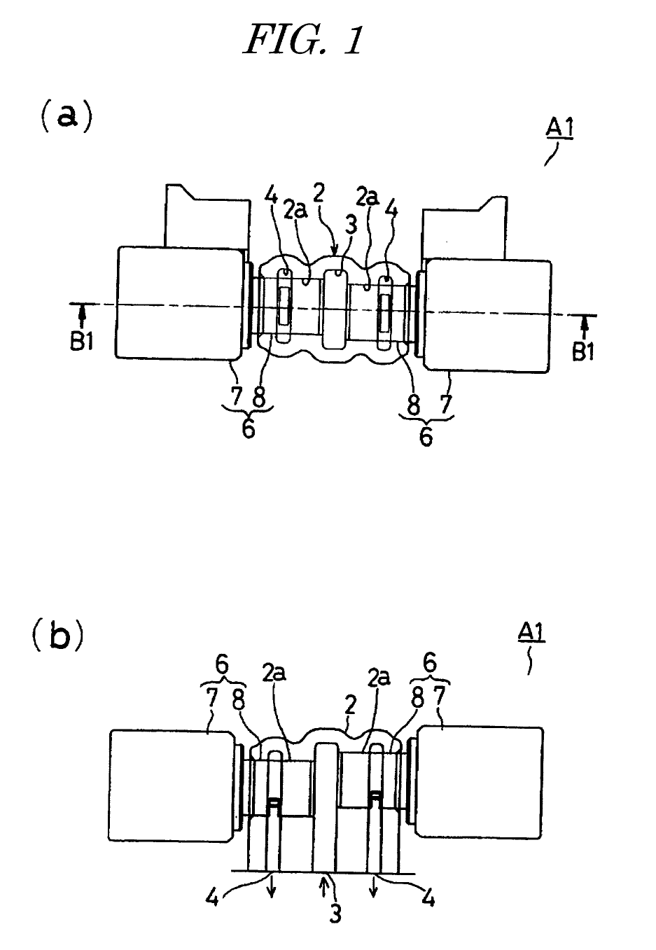

In the embodiment depicted in FIG. 1, an oil pressure solenoid valve assembly A1 includes a single oil feed port 3 and a plurality of oil discharge ports 4, 4, all formed in a valve body 2. The oil feed port 3 communicates with oil discharge ports 4, 4 through central bores 2a, 2a, respectively. Valve discs 8, 8, operated by respective solenoids, are respectively fitted in central bores 2a, 2a. Oil supplied from an oil pressure source to the oil feed port 3 is discharged through oil discharge ports 4, 4 via the valve disc portions 8, 8, as feeds to various oil pressure actuators through respective oil passages.

Solenoid valve assembly A1 includes a plurality of solenoid valves 6 and 6. Each solenoid valve 6 includes a solenoid portion 7 and a valve disc portion 8 fitted into the central bore 2a and driven by the solenoid portion 7. A solenoid valve 6 is provided for each oil discharge hole 4.

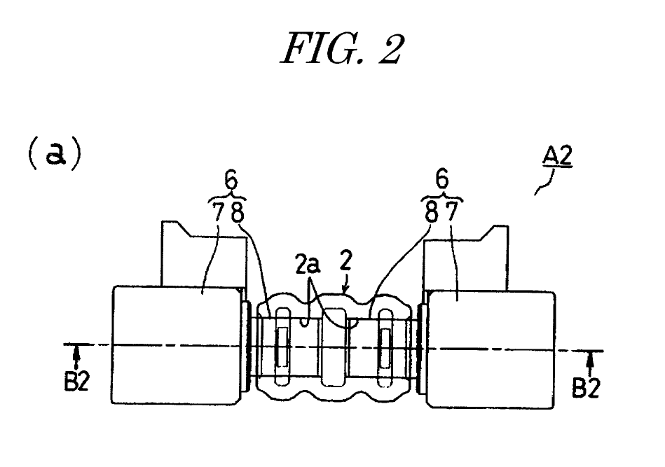

As shown in FIG. 1, two oil discharge ports 4, 4 are disposed on opposite sides of the single oil feed port 3. Two solenoid valves 6 (each including a solenoid portion 7 and a valve disc portion 8) are disposed on opposite sides of the oil feed port 3 and in opposition to each other. In this case, the two valve disc portions 8 and 8 are preferably aligned with each other on the same axis as shown in FIG. 2. In this manner, the central bores 2a and 2a are disposed coaxially and together define one through-hole. Only a single boring is required to form this through-hole, and the number of man-hours and the machining cost can thereby be decreased as compared with the case where the two central bores are individually bored.

While the oil pressure solenoid valve assemblies A1 and A2 shown in FIGS. 1 and 2 each include two oil discharge ports 4 and two solenoid valves 6, the invention is not limited to such a construction. For example, a plurality of sets of solenoids, each set comprising two solenoids, may be used as well. Also, three or more sets of solenoid valves may be arranged circumferentially around the oil feed port as the center.

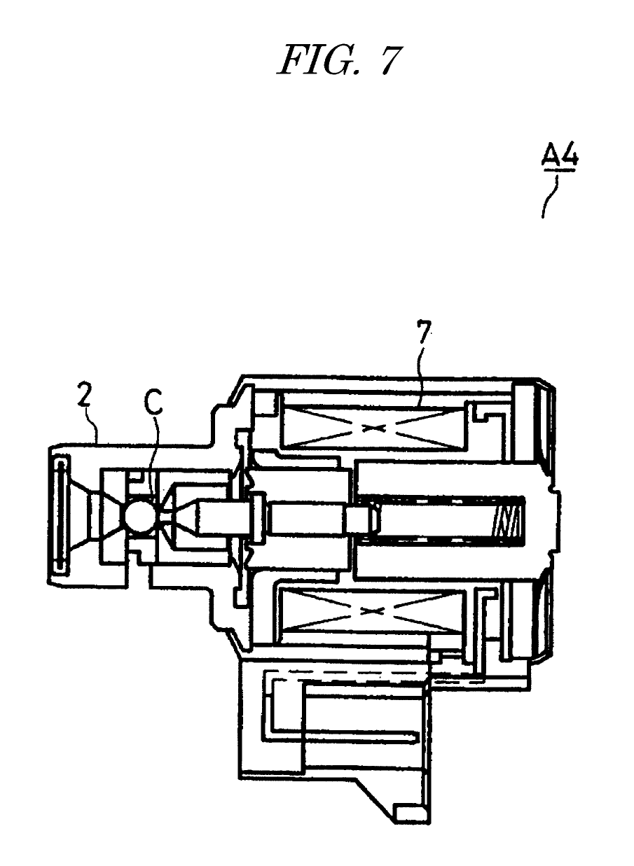

FIG. 7 is a sectional view that shows details of the oil pressure solenoid valve according to this invention. As illustrated in FIG. 7, the solenoid valve is a three-way type solenoid valve. In the three-way type solenoid valve, the oil supplied to the oil feed port is either discharged from the oil discharge port or is cut off by a check ball, but is never discharged at an exhaust port. Therefore, when one oil feed port is shared in common by a plurality of solenoid valves, the oil of the oil feed port is never discharged from an exhaust port during the control operation of one of the solenoid valves and no influence is exerted on the control of other solenoid valves.

The oil pressure solenoid valve assemblies A1 and A2 described above can be used in various oil pressure operated devices. For instance, the oil pressure solenoid valve assembly A1 or A2 can be used in an automatic transmission for an automobile, e.g. in a CVT stage-less transmission using a pulley or other automatic transmission. When the operating oil is supplied from the oil pressure solenoid valve assembly A1 or A2 to the transmission, a speed change can be achieved in the transfer path of the driving force from the car engine to the wheels.

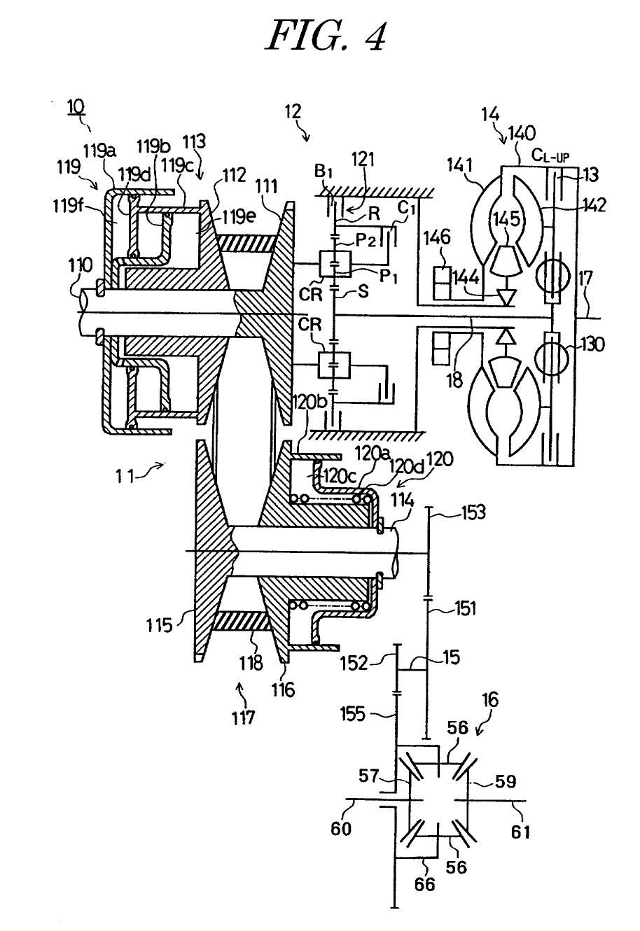

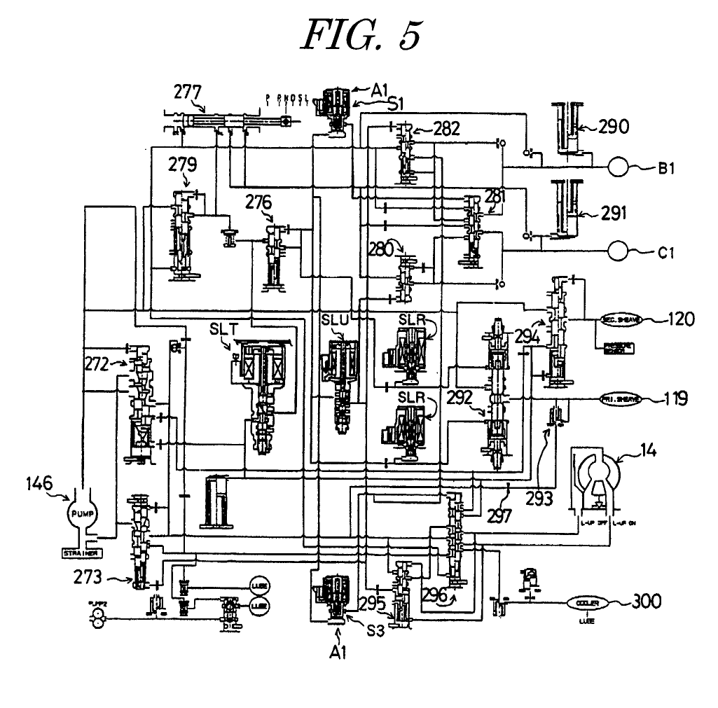

An example of an automotive automatic transmission equipped with the oil pressure solenoid valve assembly A1 described above will be briefly explained with reference to FIGS. 4 and 5.

The stage-less transmission 10 shown in FIG. 4 includes a CVT (a belt type stage-less transmission) 11, a forward/reverse switching device 12, a torque converter 14 with a built-in lock-up clutch 13, a counter-shaft 15 and a differential device 16. These components are all housed in a split case (not shown).

The torque converter 14 includes a pump impeller 141 interconnected to an engine output shaft 17 through a front cover 140, a turbine runner 142 interconnected to an input shaft 18 and a stator 145 supported through a one-way clutch 144. The lock-up clutch 13 is interposed between the input shaft 18 and the front cover 140. A damper spring 130 is interposed between a lock-up clutch plate and the input shaft 18, and an oil pump 146 is connected to, and driven by, the pump impeller 141.

The CVT 11 includes a primary pulley 113 comprising a stationary sheave 111 fixed to a primary shaft 110 and a movable sheave 112 supported by the primary shaft 110 in such a manner as to allow free sliding in an axial direction, a secondary pulley 117 comprising a stationary sheave 115 fixed to a secondary shaft 114 and a movable sheave 116 supported by the secondary shaft 114 in such a manner as to allow free sliding in the axial direction, and a metal belt 118 wound around the primary pulley 113 and the secondary pulley 117.

An oil pressure actuator 119 comprising a double piston is disposed on the rear surface of the movable sheave 112 on the primary side and an oil pressure actuator 120 comprising a single piston is disposed on the rear surface of the movable sheave 116 on the secondary side. The oil pressure actuator 119 on the primary side includes a cylinder member 119a and a reaction support member 119b that are fixed to the primary shaft 110, and a cylindrical member 119c and a piston member 119d that are fixed to the movable sheave 112. The rear surfaces of the cylindrical member 119c, reaction support member 119b and movable sheave 112 constitute a first oil pressure chamber 119e, and the cylinder member 119a and the piston member 119d together constitute a second oil pressure chamber 119f.

The oil pressure actuator 120 on the secondary side includes a reaction support member 120a fixed to the secondary shaft 114 and a cylindrical member 120b fixed to the rear surface of the movable sheave 116, and the reaction support member 120a and the cylindrical member 120b together constitute an oil pressure chamber 120c. A pre-load spring 120d is interposed in a compressed state between the movable sheave 116 and the reaction support member 120a.

The forward/reverse switching device 12 includes a double pinion planetary gear 121, a reverse brake B1 and a forward clutch C1. A sun gear S of the double pinion planetary gear 121 is interconnected to the input shaft 18. A carrier CR that supports first and second pinions P1 and P2 is interconnected to the stationary sheave 111 on the primary side. A ring gear R is interconnected to the reverse brake B1. The forward clutch C1 is interposed between the carrier CR and the ring gear R.

A large gear 151 and a small gear 152 are fixed to the counter shaft 15. The large gear 151 meshes with a gear 153 fixed to the secondary shaft 114 and the small gear 152 meshes with a gear 155 of the differential gear device 16. In the differential gear device 16, the revolution of a differential gear 56 supported by a differential gear case 66 having the gear 155 is transmitted to right and left wheels 61, 60 through right and left side gears 59, 57.

FIG. 5 shows the oil pressure circuit of the stage-less transmission 10 described above as including an oil pump 146, a primary regulator valve 272, a secondary regulator valve 273, a modulator valve 276 for a solenoid, a linear solenoid valve SLT for controlling a line pressure, a linear solenoid valve SLU for controlling a lock-up clutch and a manual valve 277. A modulated pressure (oil pressure at port PL) which is governed by a clutch modulator valve 279 through a manual operation is fed to a plurality of right and left ports shown in the drawing. The hydraulic control circuit further includes a C1 control valve 280, a relay valve 281, a B1 control valve 282 that also functions as a reverse inhibit valve, a solenoid valve S1 for switching a relay valve, an oil pressure servo C1 of the forward clutch C1 described above, an oil pressure servo B1 for the reverse brake B1 described above, and accumulators 290 and 291 for B1 and C1, respectively.

Reference numeral 292 denotes a ratio control valve. Reference numerals 119 and 120 denote the oil pressure actuator on the primary side and the oil pressure actuator on the secondary side, respectively. A check valve 293 connects the secondary regulator valve 273 and the oil pressure actuator 119 on the primary side through an orifice 297 so that the oil pressure can be freely supplied only from the side of the secondary regulator valve 273 to the side of the oil pressure actuator 119. A linear solenoid valve SLR controls the ratio control valve 292.

The hydraulic control circuit of FIG. 5 further includes a primary sheave control valve, a lock-up control valve 295, a lock-up relay valve 296 and a B1 control valve/lock-up relay valve switching solenoid valve S3. In the drawing, symbol EX represents a drain port and reference numeral 300 denotes a cooler.

When the oil pressure solenoid valve assembly A1 described above is used for such a stage-less transmission 10, the relay valve switching solenoid valve S1 and the lock-up switching solenoid valve S3 may be integrated with each other, or two ratio control linear solenoid valves SLR may be integrated.

In operation, when the solenoid portion 7 drives the valve disc portion 8 to allow oil to be supplied to the oil feed port 3, the oil is supplied from the oil feed port 3 to the oil discharge port 4, or the supply of the oil is cut off. In this embodiment, each valve disc portion 8 is individually driven by its own dedicated solenoid valve 6. As a consequence, the supply or cut-off of the oil can be individually controlled for each oil discharge port 4.

Thus, in the embodiment of FIG. 5, a plurality of solenoid valves 6, 6 share the oil feed port 3. Therefore, the number of the oil feed ports, one of which has been required for each solenoid valve in the conventional valve assembly, can be decreased. In other words, the oil pressure solenoid valve assembly A1 or A2 needs only one oil feed port 3, though it necessarily includes a plurality of oil discharge ports, and the number of the oil feed ports can be reduced in comparison with the conventional oil pressure solenoid valve assembly wherein the number of oil discharge ports equals the number of oil feed ports. Therefore, the overall size and weight of the valve body can be reduced.

One oil pressure solenoid valve assembly A1 or A2 includes a plurality of oil discharge ports 4 for discharging the oil. Moreover, the oil discharged from each oil discharge port 4 can be individually controlled. When such an oil pressure solenoid valve assembly is used for an oil pressure controller, the number of oil pressure solenoid valve assemblies can be decreased in comparison with the conventional art, and the number of the feed oil passages connecting to the oil feed ports can also be decreased. As a consequence, the size and weight of the oil pressure controller can be reduced.

When one oil feed port 3 and two oil discharge ports 4 are used as shown in FIGS. 1 and 2, wherein two oil discharge ports 4, 4, two solenoid valves 7, 7 and two valve disc portions 8, 8 are disposed opposing one another on opposite sides of the one oil feed port 3, the number of the oil feed ports can be reduced by half in comparison with the conventional arrangement having one oil feed port for each oil discharge port. Similarly, the number of the feed oil passages interconnected to the oil feed port 3 can be reduced to half the number in the conventional apparatus. Consequently, the oil pressure apparatus can be rendered more compact in size and lighter in weight.

When the two valve disc portions 8 and 8 are so disposed as to coaxially oppose each other as shown in FIG. 2, the central bores 2a and 2a, into which the valve disc portions 8 and 8 are fitted, come into perfect conformity and define one through-hole. This through-hole can be formed by one boring, and the number of man-hours and the machining costs can be reduced as compared with the case where the two central bores 2a and 2a are individually bored.

This invention is not limited to the above-mentioned embodiments, but can be variously modified within the spirit of the invention, and such modifications are intended to be included within the scope of the invention.

The teachings of Japanese Application No. H11-368434, filed Dec. 24, 1999 are incorporated herein in their entirety, inclusive of the specification, claims and drawings.

What is claimed is:

1. An oil pressure solenoid valve assembly comprising a single valve body having a central bore and, in communication with the central bore, a single oil feed port and a plurality of discharge ports;
a plurality of valve disc members mounted within said single valve body, each of said valve disc members being associated with one of said oil discharge ports for selectively opening or closing oil communication through said central bore between the single oil feed port and the associated oil discharge port; and
a plurality of independently operable solenoids each of said solenoids independently driving one of said valve disc members to selectively control oil flow through an oil discharge port associated with said one valve disc member.

2. An oil pressure solenoid valve assembly according to claim 1, wherein the plural oil discharge ports are two in number and are disposed on opposite dies of the single oil feed port which is interposed between them, and the plural solenoids are two in number and the valve disc members are two in number, with the two valve disc members opposing one another on opposite sides of the one oil feed port interposed therebetween.

3. An oil pressure solenoid valve assembly according to claim 2, wherein the two valve disc members are arranged on the same axis and fitted in respective chambers in said single valve body.

4. An oil pressure solenoid valve assembly according to claim 1 wherein said single valve body is formed as a single piece.
